(19) United States
(12) Patent Application Publication
(10) Pub. No.: US 2023/0347349 A1
(43) Pub. Date: Nov. 2, 2023

(54) COMPOSITE TOP PLATE FOR MAGNETIC AND TEMPERATURE CONTROL IN A DIGITAL MICROFLUIDIC DEVICE

(71) Applicant: Nuclera Nucleics Ltd, Cambridge (GB)

(72) Inventor: Richard J. Paolini, Jr., Billerica, MA (US)

(21) Appl. No.: 18/025,354

(22) PCT Filed: Sep. 10, 2021
(86) PCT No.: PCT/GB2021/052355

§ 371 Date: Mar. 8, 2023

Related U.S. Application Data
(60) Provisional application No. 63/076,539, filed on Sep. 10, 2020.

(51) Int. Cl. B01L 3/00

(52) U.S. Cl. CPC B01L 3/502792; B01L 2200/0647; B01L 2200/0673; B01L 2200/12; B01L 2300/0645; B01L 2300/1805; B01L 2300/12; B01L 2400/043

(57) ABSTRACT

A digital microfluidic device, comprising: (a) a bottom plate comprising a plurality of pixel electrodes; (b) a composite top plate comprising: a top plate substrate of a first material; a top plate common electrode, and a plurality of penetrations through the top plate substrate, wherein at least one of the penetrations contains a second material having at least one of: a higher thermal conductivity than the first material, and a higher magnetic permeability than the first material.

### BACKGROUND

Digital microfluidic devices (DMF) use independent electrodes to propel, split, and join droplets in a confined environment, thereby providing a “lab-on-a-chip.” Digital microfluidic devices are alternatively referred to as electrowetting on dielectric, or “EWoD,” to further differentiate the method from competing microfluidic systems that rely on electrophoretic flow and/or micropumps. A 2012 review of the electrowetting technology was provided by Wheeler in “Digital Microfluidics,” Annu. Rev. Anal. Chem. 2012, 5:413-40, which is incorporated herein by reference in its entirety. The technique allows sample preparation, assays, and synthetic chemistry to be performed with tiny quantities of both samples and reagents. In recent years, controlled droplet manipulation in microfluidic cells using electrowetting has become commercially-viable, and there are now products available from large life science companies, such as Oxford Nanopore.

Most of the literature reports on EWoD involve so-called “passive matrix” devices (a.k.a.“segmented” devices), whereby ten to twenty electrodes are directly driven with a controller. While segmented devices are easy to fabricate, the number of electrodes is limited by space and driving constraints. Accordingly, it is not possible to perform massive parallel assays, reactions, etc. in passive matrix devices. In comparison, “active matrix” devices (a.k.a. active matrix EWoD, a.k.a. AM-EWoD) devices can have many thousands, hundreds of thousands or even millions of addressable electrodes. The electrodes are typically switched by thin-film transistors (TFTs) and droplet motion is programmable so that AM-EWoD arrays can be used as general purpose devices that allow great freedom for controlling multiple droplets and executing simultaneous analytical processes.

In a DMF, there are many peripheral controls that are useful in making a full device. Two typical controls for a DMF device are temperature and magnetic field. These parameters need to be controlled in both magnitude and in location on the device to be most effective. In a DMF device one important complicating factor is the presence of relatively thick glass or plastic substrates for the conductor layers. The substrates provide the dimensional stability needed to hold a constant narrow gap for the device, and are typically about 0.5 mm or thicker. It is difficult to precisely control temperature or magnetic field especially through thick glass. Energy is wasted heating up the substrate when it is really only desired to control the temperature of the reagents inside the device. For the magnetic field used frequently for handling magnetic beads acting as reagent carriers, the field drops very quickly in intensity through thick substrates, but in a high resolution DMF device where a pixel might be 200 microns in size. As such, it may be very difficult to control the magnetic field at such high resolution given the thickness of the glass substrate in the top plate of the DMF.

### SUMMARY OF INVENTION

In a first aspect, the present application addresses the shortcomings of the prior art by disclosing an alternate architecture for a top plate featuring penetrations for thermal and magnetic control. In one aspect, there is provided a digital microfluidic device, comprising: (a) a bottom plate comprising a plurality of pixel electrodes; (b) a composite top plate comprising: a top plate substrate of a first material; a top plate common electrode, and a plurality of penetrations through the top plate substrate, wherein at least one of the penetrations contains a second material having at least one of: a higher thermal conductivity than the first material, and a higher magnetic permeability than the first material. The top plate and the bottom plate are provided in a spaced relationship defining a microfluidic space therebetween to permit droplet motion within the microfluidic space under application of propulsion voltages between the bottom electrode array and the common top electrode.

In a second aspect, there is provided a method of performing a droplet operation, the method comprising heating a droplet in the microfluidic space of the digital microfluidic device of the first aspect. Also provided is a method of performing a droplet operation, the method comprising manipulating magnetic beads in the microfluidic space of the digital microfluidic device of the first aspect.

In a third aspect, the present application provides a method for manufacturing a composite substrate the method comprising: forming a plurality of penetrations in a substrate of a first material, and inserting in the penetrations a second material having a higher magnetic permeability than the first material.

In a fourth aspect, provided herein a digital microfluidic device, comprising: (a) a bottom plate comprising a plurality of pixel electrodes; (b) a composite top plate comprising: a top plate substrate of a first material; a top plate common electrode, and a plurality of penetrations through the top plate substrate. The top plate and the bottom plate are provided in a spaced relationship defining a microfluidic space therebetween. The penetrations create at least one high-resolution zone in the microfluidic space, wherein the high-resolution zone has at least one of: a higher thermal resolution than in the digital microfluidic device without the penetrations, and a higher magnetic resolution than in the digital microfluidic device without the penetrations.

In a fifth aspect, there is provided a digital microfluidic device, comprising: (a) a bottom plate comprising a plurality of pixel electrodes; (b) a composite top plate comprising: a top plate substrate of a first material; a top plate common electrode, and a plurality of penetrations through the top plate substrate. The top plate and the bottom plate are provided in a spaced relationship defining a microfluidic space therebetween; and the penetrations create at least one high-resolution zone and a low-resolution zone in the microfluidic space, wherein the high-resolution zone has at least one of: a higher thermal resolution than the low-resolution zone, and a higher magnetic resolution than in the low-resolution zone.

### BRIEF DESCRIPTION OF DRAWINGS

FIG. 1A is a diagrammatic cross-section of the cell of an example EWoD device.

FIG. 1B illustrates EWoD operation with DC Top Plane. FIG. 1C illustrates EWoD operation with TPS.

FIG. 2 is a schematic diagram of a TFT connected to a gate line, a source line, and a pixel electrode.

FIG. 3 is a diagrammatic view of an exemplary driving system for controlling droplet operation by an AM-EWoD pixel electrode array.

FIG. 4 is a schematic diagram of a composite top plate featuring penetrations filled with material(s) having higher thermal conductivity and higher magnetic conductivity than the glass substrate.

FIG. 5 is a schematic diagram of a composite top plate featuring shaped penetrations for achieving thermal and magnetic performance control.

FIG. 6 is a top view schematic illustration of an array of filled top plate penetrations in a composite top plate.

FIG. 7 is a schematic diagram comparing the extent of temperature control as achieved in traditional DMF configurations as compared to a composite top plate.

### DEFINITIONS

Unless otherwise noted, the following terms have the meanings indicated.

“Actuate” with reference to one or more electrodes means effecting a change in the electrical state of the one or more electrodes which, in the presence of a droplet, results in a manipulation of the droplet.

“Droplet” means a volume of liquid that electrowets a hydrophobic surface and is at least partially bounded by carrier fluid. For example, a droplet may be completely surrounded by carrier fluid or may be bounded by carrier fluid and one or more surfaces of an EWoD device. Droplets may take a wide variety of shapes; non-limiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more working surface of an EWoD device. Droplets may include typical polar fluids such as water, as is the case for aqueous or non-aqueous compositions, or may be mixtures or emulsions including aqueous and non-aqueous components. The specific composition of a droplet is of no particular relevance, provided that it electrowets a hydrophobic working surface. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include one or more reagent, such as water, deionized water, saline solutions, acidic solutions, basic solutions, detergent solutions and/or buffers. Other examples of droplet contents include reagents, such as a reagent for a biochemical protocol, a nucleic acid amplification protocol, an affinity-based assay protocol, an enzymatic assay protocol, a gene sequencing protocol, a protein sequencing protocol, and/or a protocol for analyses of biological fluids. Further example of reagents include those used in biochemical synthetic methods, such as a reagent for synthesizing oligonucleotides finding applications in molecular biology and medicine, and/or one more nucleic acid molecules. The oligonucleotides may contain natural or chemically modified bases and are most commonly used as antisense oligonucleotides, small interfering therapeutic RNAs (siRNA) and their bioactive conjugates, primers for DNA sequencing and amplification, probes for detecting complementary DNA or RNA via molecular hybridization, tools for the targeted introduction of mutations and restriction sites in the context of technologies for gene editing such as CRISPR-Cas9, and for the synthesis of artificial genes by “synthesizing and stitching together” DNA fragments.

“Droplet operation” means any manipulation of one or more droplets on a microfluidic device. A droplet operation may, for example, include: loading a droplet into the microfluidic device; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a microfluidic device; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles.

“Gate driver” is a power amplifier that accepts a low-power input from a controller, for instance a microcontroller integrated circuit (IC), and produces a high-current drive input for the gate of a high-power transistor such as a TFT. “Source driver” is a power amplifier producing a high-current drive input for the source of a high-power transistor.

“Nucleic acid molecule” is the overall name for DNA or RNA, either single- or double-stranded, sense or antisense. Such molecules are composed of nucleotides, which are the monomers made of three moieties: a 5-carbon sugar, a phosphate group and a nitrogenous base. If the sugar is a ribosyl, the polymer is RNA (ribonucleic acid); if the sugar is derived from ribose as deoxyribose, the polymer is DNA (deoxyribonucleic acid). Nucleic acid molecules vary in length, ranging from oligonucleotides of about 10 to 25 nucleotides which are commonly used in genetic testing, research, and forensics, to relatively long or very long prokaryotic and eukaryotic genes having sequences in the order of 1,000, 10,000 nucleotides or more. Their nucleotide residues may either be all naturally occurring or at least in part chemically modified, for example to slow down in vivo degradation. Modifications may be made to the molecule backbone, e.g. by introducing nucleoside organothiophosphate (PS) nucleotide residues. Another modification that is useful for medical applications of nucleic acid molecules is 2′ sugar modifications. Modifying the 2′ position sugar is believed to increase the effectiveness of therapeutic oligonucleotides by enhancing their target binding capabilities, specifically in antisense oligonucleotides therapies. Two of the most commonly used modifications are 2′-O-methyl and the 2′-Fluoro.

When a liquid in any form (e.g., a droplet or a continuous body, whether moving or stationary) is described as being “on”, “at”, or “over an electrode, array, matrix or surface, such liquid could be either in direct contact with the electrode/array/matrix/surface, or could be in contact with one or more layers or films that are interposed between the liquid and the electrode/array/matrix/surface.

When a droplet is described as being “on” or “loaded on” a microfluidic device, it should be understood that the droplet is arranged on the device in a manner which facilitates using the device to conduct one or more droplet operations on the droplet, the droplet is arranged on the device in a manner which facilitates sensing of a property of or a signal from the droplet, and/or the droplet has been subjected to a droplet operation on the droplet actuator.

“Each,” when used in reference to a plurality of items, is intended to identify an individual item in the collection but does not necessarily refer to every item in the collection. Exceptions can occur if explicit disclosure or context clearly dictates otherwise.

### DETAILED DESCRIPTION

The present application provides a digital microfluidic device including a composite top plate and a bottom plate defining a microfluidic space. A number of traditional devices feature penetrations through the top plate to allow electrochemical sensors direct access to the fluid in the DMF device. Others show structures and electrodes on the upper surfaces of the top plate substrate. There does not seem to be any mention of regional penetrations through the top substrate to allow both temperature and magnetic access to the microfluidic space without the inconvenience of the intervening top plate substrate material. Therefore, temperature control still requires localized heating of liquids in the microfluidic space through the top plate substrate, which is complex and inaccurate. Also, magnetic bead handling through top plate substrates requires strong magnets and the long separation distance means larger fringe fields and lower resolution.

In one aspect, the present application provides a composite top plate of a spatially heterogeneous composition. This composite structure allows for the localized delivery of thermal energy to specific zones of the microfluidic space while minimizing heat flow through the substrate, thereby attaining heating zones with a finer thermal resolution than possible with traditional, homogeneous top plates. Similarly, the composite architecture of the invention also top plate also enables a finer magnetic resolution, that is, a more spatially precise application of localized magnetic fields which are no longer required to penetrate through the top plate substrate. As a result, high-resolution zones are created in the microfluidic space and precise control of temperature and magnetic actuation in the DMF device is achieved without any change to the bottom plate pixel electrodes. Only the top plate structure is modified, which is typically much less complex and less expensive to accomplish.

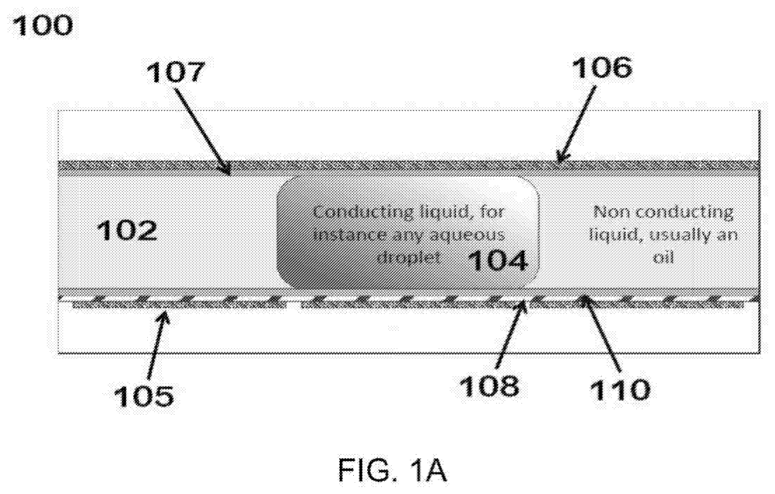

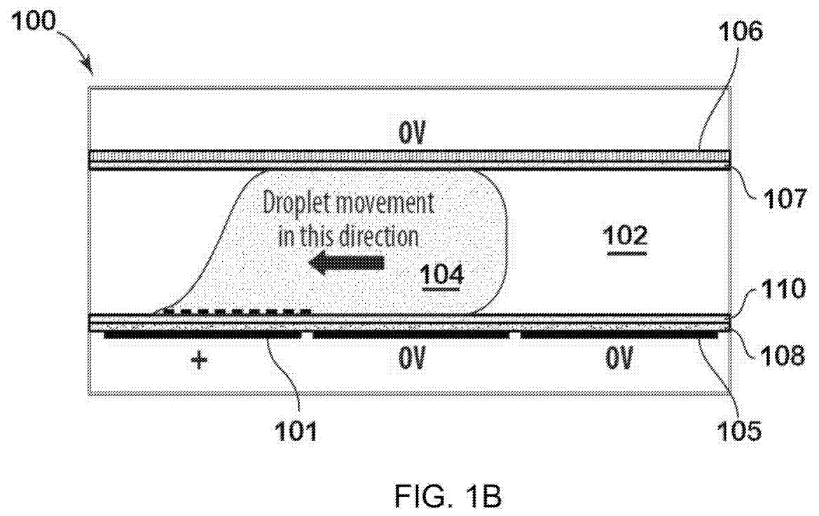

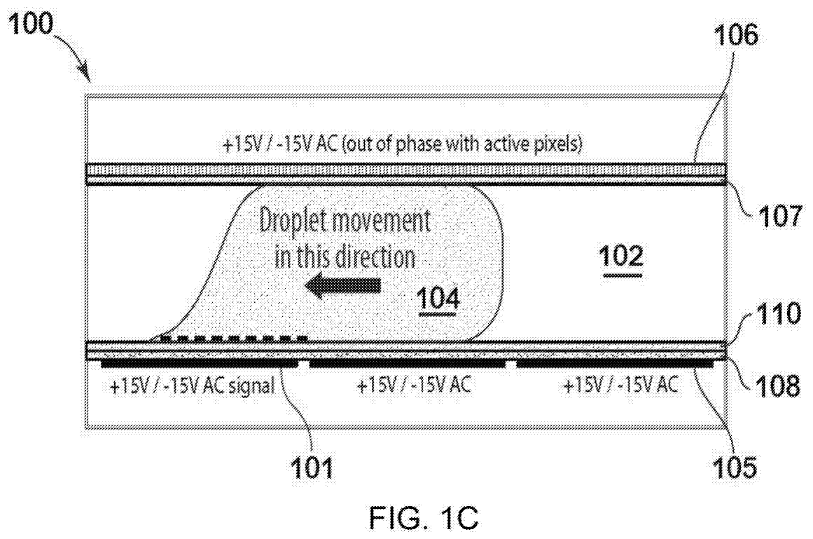

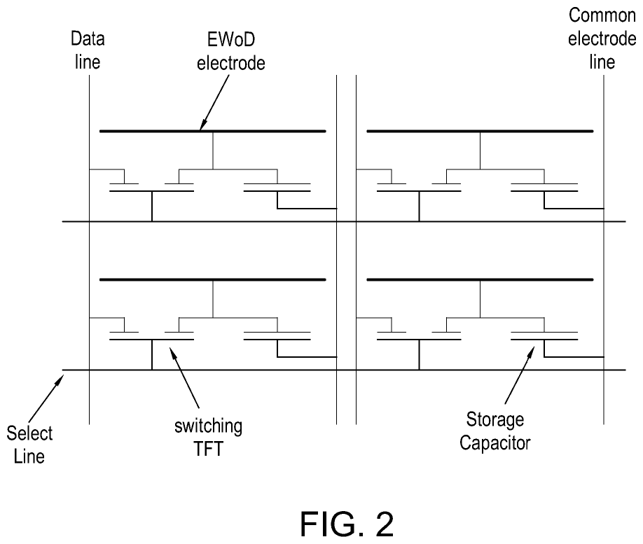

Before proceeding further, it is desirable to illustrate the architecture of a typical DMF device. FIG. 1A shows a diagrammatic cross-section of the cell in an example traditional, closed configuration DMF device where droplet 104 is surrounded on the sides by carrier fluid 102 and sandwiched between top hydrophobic layer 107 and bottom hydrophobic layer 110. Typical cell spacing is usually in the range of about 120 μm to about 500 μm. A plurality of pixel electrodes 105 are disposed on one substrate and a single, common top electrode 106 is disposed on the opposing surface. The device additionally includes a dielectric layer 108 between the pixel electrodes 105 and the hydrophobic coating 107.

The hydrophobic layers prevent the droplet from wetting the surfaces. Hydrophobic layers may be manufactured from hydrophobic materials formed into coatings by deposition onto a surface via suitable techniques. Depending on the hydrophobic material to be applied, example deposition techniques include spin coating, molecular vapor deposition, and chemical vapor deposition. Hydrophobic layers may be more or less wettable as usually defined by their respective contact angles. Surface wettabilities may be measured by analytical methods well known in the art, for instance by dispensing a droplet on the surface and performing contact angle measurements using a contact angle goniometer. Anisotropic hydrophobicity may be examined by tilting substrates with gradient surface wettability along the transverse axis of the pattern and examining the minimal tilting angle that can move a droplet.

Unless otherwise specified, angles are herein measured in degrees)(° or radians (rad), according to context. For the purpose of measuring the hydrophobicity of a surface, the term “contact angle” is understood to refer to the contact angle of the surface in relation to deionized (DI) water. If water has a contact angle between 0°<θ<90°, then the surface is classed as hydrophilic, whereas a surface producing a contact angle between 90°<θ<180° is considered hydrophobic. Usually, moderate contact angles are considered to fall in the range from about 90° to about 120°, while high contact angles are typically considered to fall in the range from about 120° to about 150°. In instances where the contact angle is 150°<θ then the surface is commonly known as superhydrophobic or ultrahydrophobic.

Hydrophobic layers of moderate contact angle typically include one or a blend of fluoropolymers, such as PTFE (polytetrafluoroethylene), FEP (fluorinated ethylene propylene), PVF (polyvinylfluoride), PVDF (polyvinylidene fluoride), PCTFE (polychlorotrifluoroethylene), PFA (perfluoroalkoxy polymer), FEP (fluorinated ethylenepropylene), ETFE (polyethylenetetrafluoroethylene), and ECTFE (polyethylenechlorotrifluoroethylene). Commercially available fluoropolymers include Cytop® (AGC Chemicals, Exton, PA) and Teflon® AF (Chemours, Wilmington, DE). An advantage of fluoropolymer films is that they can be highly inert and can remain hydrophobic even after exposure to oxidizing treatments such as corona treatment and plasma oxidation.

A propulsion voltage is defined by a voltage difference between a pixel electrode and the common top electrode. By adjusting the frequency and amplitude of the signals driving the pixel electrodes and top electrode, the propulsion voltage of each pixel of the DMF device may be controlled to operate the device at different modes of operation in accordance with different droplet manipulation operations to be performed. When no voltage differential is applied between adjacent electrodes, the droplet will typically maintain a spheroidal shape to minimize contact with the hydrophobic surfaces (oil and hydrophobic layer). Because the droplets do not wet the surface, they are less likely to contaminate the surface or interact with other droplets except when that behavior is desired. When a voltage differential is applied between adjacent electrodes, the voltage on one electrode attracts opposite charges in the droplet at the dielectric-to-droplet interface, and the droplet moves toward this electrode, also as illustrated in FIG. 1. The voltages needed for acceptable droplet propulsion depend on the properties of the dielectric and hydrophobic layers. AC driving is used to reduce degradation of the droplets, dielectrics, and electrodes by various electrochemistries. Operational frequencies for EWoD can be in the range 50 Hz to 1 MHz, but lower frequencies of 1 kHz or lower are preferred for use with TFTs that have limited speed of operation.

As outlined above, there are two main categories of DMF bottom plates, depending on how bottom plate electrodes 105 are driven: an active matrix and a passive matrix bottom plate. There is no limitation to the type of bottom plate which may be used in the various embodiments of the present invention. In a representative embodiment, the bottom plate of the device includes an active matrix electrowetting on dielectric (AM-EWoD) system featuring a plurality of array elements, each array element including a pixel electrode, although other configurations for driving the bottom plate electrodes are also contemplated. The AM-EWoD matrix may be in the form of a transistor active matrix bottom plate, for example a thin film transistor (TFT) bottom plate where each pixel electrode is operably attached to a transistor and capacitor actively maintaining the electrode state while the electrodes of other array elements are being addressed. The TFT is addressed by a set of narrow multiplexed electrodes (gate lines and source lines). A pixel is addressed by applying voltage to a gate line that switches the TFT on and allows a charge from the source line to flow on to the rear electrode. This sets up a voltage across the pixel and turns it on.

There are two main modes of driving the common top plane electrode 106: “DC Top Plane” and “Top Plane Switching (TPS)”. FIG. 1B illustrates EWoD operation in DC Top Plane mode, where the top plane electrode 106 is set to a potential of zero volts, for example by grounding. As a result, the voltage applied across the cell is the voltage on the pixel electrode 105 having a different voltage to the top plane so that conductive droplets are attracted to the electrode. In AM-EWoD cells where the transistors of the matrix are TFT, this limits pixel driving voltages to about ±15 V because in typical amorphous silicon (a-Si) TFTs the maximum voltage is in the range from about 15 V to about 20 V due to TFT electrical instabilities under high voltage operation. FIG. 1C shows driving the cell with TPS, in which case the driving voltage is doubled to ±30 V by powering the top electrode out of phase with active pixels, such that the top plane voltage is additional to the voltage supplied by the TFT.

Amorphous silicon TFT plates usually have only one transistor per pixel. As illustrated in in FIG. 1D, this is connected to at least one gate line, at least one source line (also known as “data line”), and a pixel electrode. When there is large enough positive voltage on the TFT gate then there is low impedance between the source line and pixel (Vg “ON”), so the voltage on the source line is transferred to the electrode of the pixel. When there is a negative voltage on the TFT gate then the TFT is high impedance and voltage is stored on the pixel storage capacitor and not affected by the voltage on the source line as the other pixels are addressed (Vg “OFF”). Ideally, the TFT should act as a digital switch. In practice, there is still a certain amount of resistance when the TFT is in the “ON” setting, so the pixel takes time to charge. Additionally, voltage can leak from Vs to Vp when the TFT is in the “OFF” setting, causing cross-talk. Increasing the capacitance of the storage capacitor Cₛ reduces cross-talk, but at the cost of rendering the pixels harder to charge.

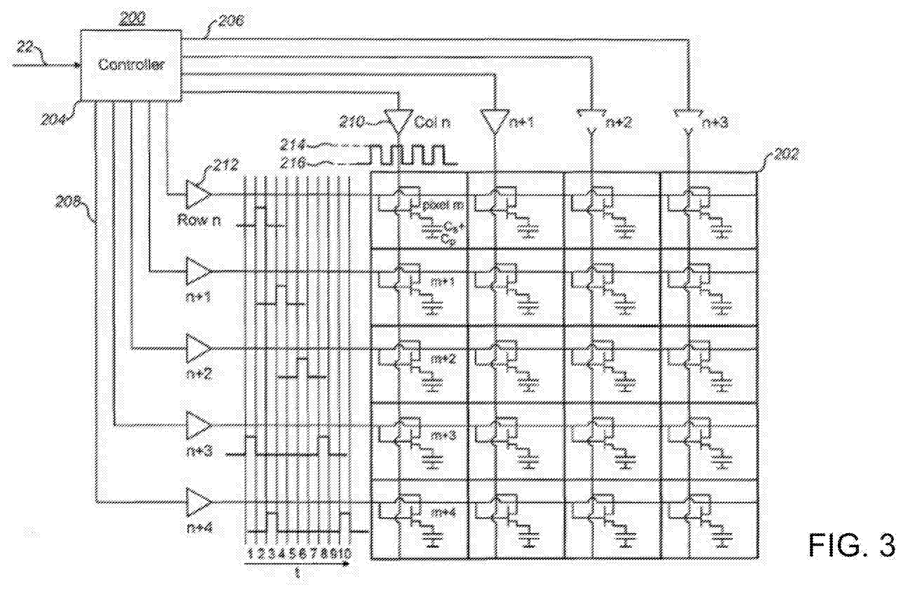

FIG. 3 is a diagrammatic view of an exemplary driving system 200 for controlling droplet operation by an AM-EWoD pixel electrode array 202. The AM-EWoD driving system 200 may be in the form of an integrated circuit adhered to a support plate. The elements of the EWoD device are arranged in the form of a matrix having a plurality of source lines and a plurality of gate lines. Each element of the matrix contains a TFT of the type illustrated in FIG. 1A for controlling the electrode potential of a corresponding electrode, and each TFT is connected to one of the gate lines and one of the source lines. The electrode of the element is indicated as a capacitor Cₚ. The storage capacitor Cₛ is arranged in parallel with Cₚ and is not separately shown in FIG. 3.

The controller shown comprises a microcontroller 204 including control logic and switching logic. It receives input instructions relating to droplet operations from a processing unit (not shown) via the input source lines 22. The processing unit may be, for example, a general purpose computer, special purpose computer, personal computer, or other programmable data processing apparatus providing processing capabilities, such as storing, interpreting, and/or executing software instructions, as well as controlling the overall operation of the device. The processing unit is coupled to a memory which includes programmable instructions to direct the processing unit to perform various operations, such as, but not limited to, providing the controller with input instructions directing it to generate electrode drive signals in accordance with embodiments herein. The memory may be physically located in the DMF device or in a computer or computer system which is interfaced to the device and hold programs and data that are part of a working set of one or more tasks being performed by the device. For example, the memory may store programmable instructions to carry out the drive schemes described in connection with a set of one or more droplet operations. The processing unit executes the programmable instructions to generate control inputs that are delivered to the controller to implement one or more drive schemes associated with a given droplet operation.

The drive schemes are defined by predetermined pulse sequences that are utilized in connection with associated electrodes during the droplet operations. Certain drive schemes may be associated with corresponding pixel electrodes. Additionally or alternatively, one or more common drive schemes may be used with all pixels or a subset of the total number of pixels. As a further example, various drive schemes may be repeated over and over, and/or may be associated with particular types of droplet operations. For example, a first drive scheme may be applied to one or more pixels to advance a droplet along a channel, while a second drive scheme is used to split a droplet or hold a droplet at a select location.

The controller has an output for each source line of the EWoD matrix, providing a data signal. A source signal line 206 connects each output to a source line of the matrix. The microcontroller also has an output for each gate line of the matrix, providing a gate line selection signal. A gate signal line 208 connects each output to a gate line of the matrix. A source line driver 210 and a gate line driver 212 is arranged in each source and gate signal line, respectively. The figure shows the signals lines only for those source lines and gate lines shown in the figure. The gate line drivers may be integrated in a single integrated circuit. Similarly, the source line drivers may be integrated in a single integrated circuit. The integrated circuit may include the complete gate driver assembly together with the microcontroller. The integrated circuit may be integrated on a support plate of the AM-EWoD device. The integrated circuit may include the entire AM-EWoD device driving system.

The source line drivers provide the source levels corresponding to a droplet operation. The gate line drivers provide the signals for selecting the gate line of which electrodes are to be actuated. A sequence of voltages of one of the source line drivers 210 is shown in the Figure. As illustrated above, when there is large enough positive voltage on the gate line then there is low impedance between the source line and pixel electrode, so the voltage on the source line is transferred to the pixel. When there is a negative voltage on the TFT gate then the TFT is high impedance and voltage is stored on the pixel capacitor and not affected by the voltage on the source line. If no movement is needed, or if a droplet is meant to move away from a pixel electrode, then 0 V, that is, no voltage differential relative to the top plate, is present on the pixel electrode. If a droplet is meant to move toward a pixel electrode, an AC voltage will be applied to that (target) pixel electrode. The figure shows four columns labelled n to n+3 and five rows labelled n to n+4.

As illustrated in FIG. 3, traditional AM-EWoD cells use line-at-a-time addressing, in which one gate line n is high while all the others are low. The signals on all of the source lines are then transferred to all of the pixels in row n. At the end of the line time gate line n signal goes low and the next gate line n+1 goes high, so that data for the next line is transferred to the TFT pixels in row n+1. This continues with all of the gate lines being scanned sequentially so the whole matrix is driven. This is the same method that is used in almost all AM-LCDs, such as mobile phone screens, laptop screens and LC-TVs, whereby TFTs control the voltage maintained across the liquid crystal layer, and in AM-EPDs (electrophoretic displays).

Composite Top Plate

As anticipated above, a novel device according to one aspect of the present invention features a composite top plate. The plate includes a relatively thick top plate substrate layer made from a dimensionally stable first material, usually about 0.5 mm or more in thickness. In exemplary embodiments, the first material may be glass or selected from among plastics commonly used in the manufacture of microfluidic devices such as polymethylmethacrylate (PMMA), polycarbonate, polyethylene terephthalate (PET), and polyimide. One or more penetrations through the top plate substrate are filled with a second material of higher thermal conductivity and magnetic relative permeability than the first material. In a representative embodiment, a ratio k₂:k₁ is within the range from at least 10:1 to at most 300:1, where k₁ stands for the thermal conductivity of the first material and k₂ stands for the thermal conductivity of the second material. In further embodiments, the ratio k₂:k₁ is at least 10:1 to at most 200:1, or at least 10:1 to at most 100:1, or at least 10:1 to at most 50:1. In an exemplary embodiment, a ratio μ₂:μ₁ is in the range of at least 10:1 to at most 100,000:1, wherein μ₁ is the magnetic relative permeability of the first material and μ₂ is the magnetic relative permeability of the second material. In an additional embodiment, the ratio μ₂:μ₁ is in the range of at least 10:1 to at most 50,000:1, or at least 10:1 to at most 10,000:1, or at least 10:1 to at most 1000:1. The ranges disclosed above should not be interpreted as being mutually exclusive. Rather, more than one material or mixture of materials may have a k₂ falling within a desired range, with one or more also being characterized by a μ₂ suitable to the application at hand.

As seen in Table 1, certain materials may be more suitable to a device where only better temperature control is desired. Aluminum, for example, is characterized by a very high thermal conductivity but would not be the best material for a dual temperature and magnetic purpose due to its relatively low magnetic relative permeability. Examples materials with more suitable properties in both temperature performance and magnetic performance include specialized metals and alloys such as mu-metal, a nickel-iron soft ferromagnetic alloy having a composition which is approximately 77% nickel, 16% iron, 5% copper, and 2% chromium or molybdenum. If the penetrations contain mu metal then one would obtain a 30:1 contrast in local heating as compared to an all-glass top plate, and an even larger contrast in local magnetic field intensity. Also as shown in Table 1, another example of suitable material is provided by permalloy, a nickel-iron magnetic alloy, with about 80% nickel and 20% iron content.

TABLE 1

| Thermal Conductivity Comparison | | | Magnetic Relative Permeability | |
|---|---|---|---|---|
| | | Ratio to | Comparison | |
| | | thermal | | Ratio to magnetic |
| | BTU/ | conductivity | | relative permeability |
| | hr/F. | of glass | | of glass |
| Glass | 0.6 | 1 | Glass | 1 |
| Aluminum | 136 | 226.7 | Aluminum | 1 |
| Stainless | 14.4 | 24.0 | Stainless | 500 |
| Steel (430) | | | Steel (430) | |
| Mu Metal | 19 | 31.7 | Mu Metal | 20,000 |
| Permalloy | 19.67 | 32.8 | Permalloy | 100,000 |

The digital microfluidic device may be fitted with a temperature controller for independently regulating the temperatures of the penetrations. In one embodiment, the temperature controller is operably coupled to an array of thermal control elements for heating or cooling the material in the penetrations, such as micro-heaters or thermocouples, thereby enabling independent temperature control in more than one penetration at a time. The micro-heaters may be in the form of heating resistor elements that are electrically connected to the controller.

Similarly, the device may also be equipped with a magnetic controller operably connected to an array or magnetic elements. The magnetic controller in a simple implementation uses a one-axis z-stage with permanent magnets that can touch the array of magnetic penetrations. If separate control is needed for each magnetic location then either electromagnetic controls and still one mechanical actuation control or multiple position controls and permanent magnets may be used. This kind of magnetic actuation stage is well known to those of skill in the art. Example magnetic elements include permanent magnets coupled to actuators. When a magnetic field is not needed at the spot in the microfluidic channel corresponding to a given penetration, the magnet is held in a first, disengaged position at a sufficient distance from the penetration. When the action of the magnetic field is desired, for example in a step where magnetic beads are manipulated, the controller instructs the actuator to move the magnet to a second, engaged position in closer proximity of or in contact with the penetration, to exert the magnetic field on the beads. In another, non-exclusive embodiment, the magnetic elements may be in the form of electromagnets. Each electromagnet may be independently activated by a driver when prompted by the controller, and may be placed in close proximity of the penetration. Alternatively, a part or all of the penetration material itself may serve as the electromagnet in instances where the material is suitable to this application.

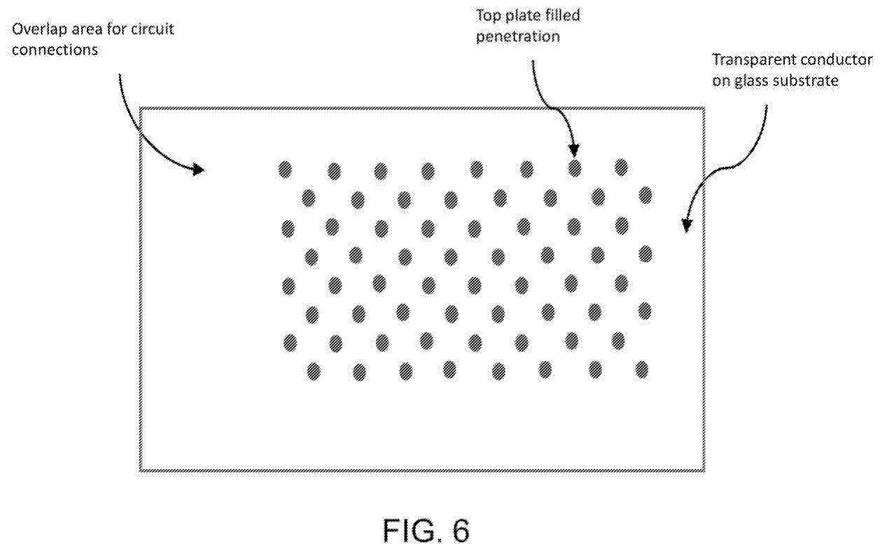

As schematically illustrated in FIG. 6, the composite substrate may also include an overlap area for circuitry connecting the temperature controller to the thermal control elements and the magnetic controller to the magnetic elements.

### Examples

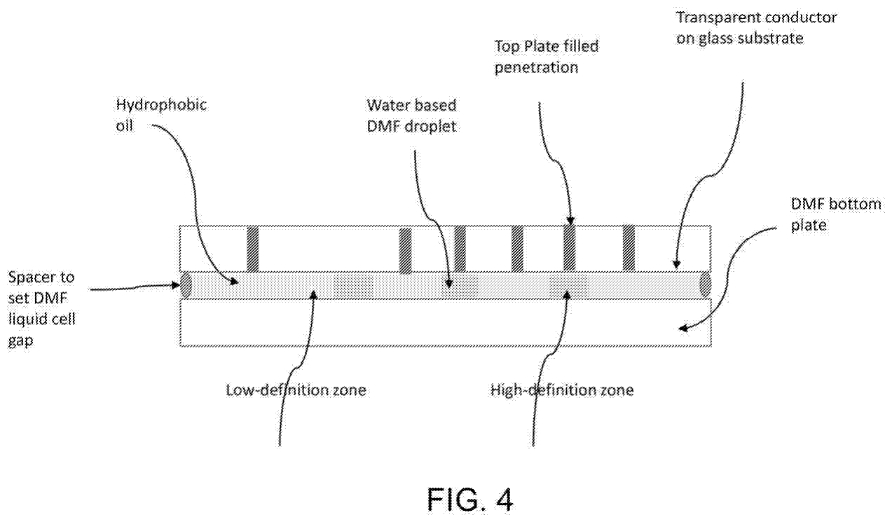

In a first non-limiting example, the DMF device includes a thin film transistor (TFT) bottom plate in the bottom plate and glass substrate electrodes for both the bottom and the top plate. The TFT is configured with 500×500 pixel electrodes having approximately 200 micron pixel size. The device may be configured to have hundreds of reaction sites where simultaneous reactions can be carried out, the sites forming an array on the device. In one configuration there are 400 reaction sites forming a 20×20 array. Each reaction site may consist of multiple pixels in area, for example about 400 pixels per reaction site, surrounded by an open path for routing reagents to each pixel. It is advantageous to be able to control temperature and magnetic field at each of the reaction sites. In this device, penetrations through the top plate span its full thickness and provide direct contact with the liquid in the microfluidic chamber. FIG. 4 is a schematic cross section of a device with a composite top plane with full thickness penetrations filled with material(s) having relatively high thermal conductivity and/or magnetic relative permeability.

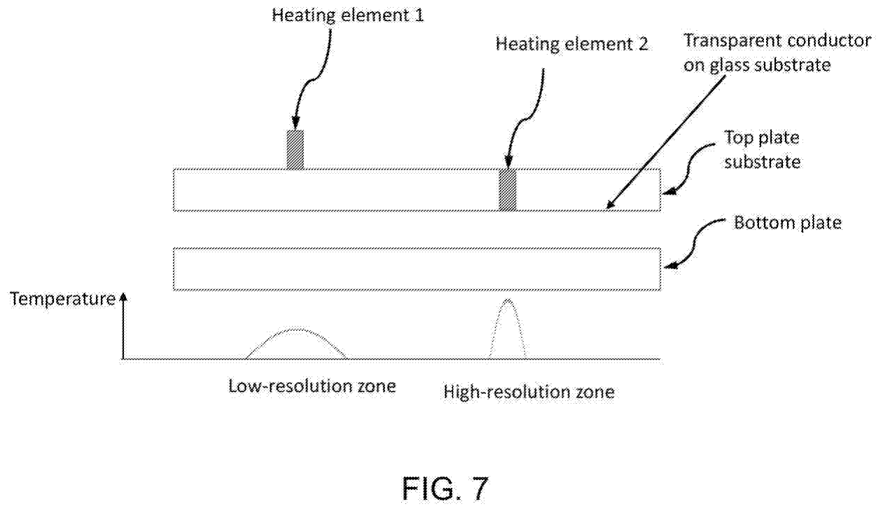

The presence of the penetrations creates one or more “high-resolution zones” which are characterized by a higher degree of thermal and magnetic control than in the absence of the penetration. FIG. 7 provides a schematic illustration of a DMF device featuring a first heating element 1 which is positioned above the top plate substrate as common in traditional architectures. Second heating element 2 is instead located within a penetration inside the top plane substrate. Plotted in the graph below the DMF device is the temperature as measured along the inner surface of the bottom plate. Because of the substrate being interposed between heating element 1 and the microfluidic space, there occurs a loss of focus in the delivery of thermal energy to its intended target zone. This in turn results in the broad and flattened temperature curve below heating element 1, which is indicative of dispersed heat delivery over a relatively large, low-resolution area. In contrast, thermal energy from heating element 2 can reach the microfluidic space in a more focused fashion. As a result, heating is more concentrated on a narrower, high-resolution area, as evidenced by the taller and thinner temperature curve formed under heating element 2. Analogous considerations apply to elements creating magnetic fields.

The composite top plate creates zones within the microfluidic space where temperature and/or magnetic fields may be controlled with steeper spatial gradients, and therefore higher spatial resolution. A high-resolution zone is typically located in close proximity to a penetration such that heat flows and/or magnetic fields can be imposed on the zone with a higher degree of spatial resolution than would be attainable with a homogeneous top plate lacking penetrations. The penetrations of FIG. 4 are cylindrical in shape, but tapered geometries may be adopted to achieve finer control, especially for localizing heating or magnetic fields down to extremely small spots sizes. Depending on the desired level of spatial resolution, the penetrations may be present in lower or higher densities. In an exemplary embodiment, at least one portion of the top plate includes from 2 to 100 penetrations per square centimeter. In another exemplary embodiments, at least one portion of the top plate includes from 5 to 50 penetrations per square centimeter. In further embodiments, at least one portion of the top plate includes from 5 to 25, 5 to 15, or 5 to 10 penetrations per square centimeter.

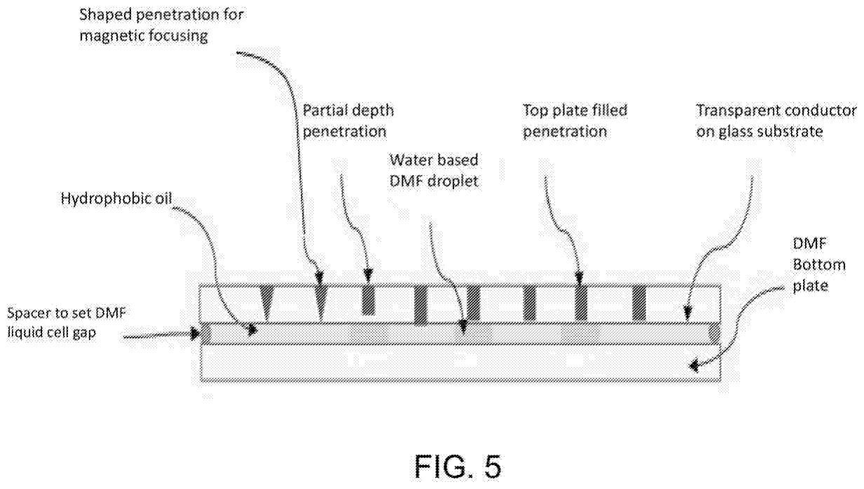

FIG. 5 illustrates conical elements that may focus temperature and magnetic control onto small locations even through glass, which would be very difficult to attain without the penetrations. FIG. 5 also shows partial depth penetrations where the penetrations do not go all the way through the plate to make contact with the liquid. This partial penetration may prove beneficial to balance temperature and magnetic performance in instances where keeping a planar surface on the electrode with hundreds of full thickness penetrations is difficult. More broadly, the number, shape, and depth of top plate penetrations in a device can be easily customized to suit any application or biological assay protocol. A device may feature any from just one to hundreds of penetrations, the latter to accommodate instances where several reactants are introduced as separate droplets from a number of reservoirs. Advantageously, the other portions of the DMF, including the TFT array on the bottom plate and relatively complex dielectric layers may remain the same for all of the device configurations.

The use of “top” and “bottom” is merely a convention as the locations of the two plates can be switched, and the devices can be oriented in a variety of ways, for example, the top and bottom plates can be roughly parallel while the overall device is oriented so that the plates are normal to a work surface (as opposed to parallel to the work surface as shown in the figures).

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense. In the event of any inconsistency between the content of this application and any of the published documents incorporated by reference herein, the content of this application shall control to the extent necessary to resolve such inconsistency.

1. A digital microfluidic device, comprising:
(a) a bottom plate comprising a plurality of pixel electrodes;
(b) a composite top plate comprising:
a top plate substrate of a first material;
a top plate common electrode, and
a plurality of penetrations through the top plate substrate, wherein at least one of the penetrations contains a second material having at least one of: a higher thermal conductivity than the first material, and a higher magnetic permeability than the first material.

2. The digital microfluidic device of claim 1, wherein a ratio k₂:k₁ is at least 10:1, wherein k₁ is the thermal conductivity of the first material and k₂ is the thermal conductivity of the second material.

3. The digital microfluidic device of claim 1, wherein a ratio μ₂: μ₁ is at least 10:1, wherein μ₁ is the magnetic relative permeability of the first material and μ₂ is the magnetic relative permeability of the second material.

4. The digital microfluidic device of any one of claims 1 to 3, wherein the first material is selected from the group consisting of glass, polymethylmethacrylate, polycarbonate, polyethylene terephthalate (PET), polyimide, and combinations thereof.

5. The digital microfluidic device of any one of claims 1 to 4, wherein the second material is a metal or metal alloy.

6. The digital microfluidic device of claim 5, wherein the second material is selected from the group consisting of aluminum, steel, mu-metal, permalloy, and combinations thereof.

7. The digital microfluidic device of any one of claims 1 to 6, wherein at least one penetration spans the full thickness of the top plate.

8. The digital microfluidic device of any one of claims 1 to 7, wherein at least one penetration is tapered.

9. The digital microfluidic device of any one of claims 1 to 8, wherein at least one penetration spans a portion smaller than the full thickness of the top plate.

10. The digital microfluidic device of any one of claims 1 to 9, further comprising a temperature controller for regulating the temperature in at least one of the penetrations, wherein the temperature controller is operably connected to a plurality of thermal control elements.

11. The digital microfluidic device of any one of claims 1 to 10, further comprising a magnetic controller for actuating a magnetic field in at least one of the penetrations, wherein the magnetic controller is operably connected to a plurality of magnetic elements.

12. The digital microfluidic device of any one of claims 1 to 11, wherein the bottom plate comprises a thin film transistor (TFT) array.

13. The digital microfluidic device of any one of claims 1 to 12, wherein at least a portion of the top plate substrate comprises 5 to 50 penetrations per square centimeter.

14. A method of performing a droplet operation, the method comprising heating a droplet in the digital microfluidic device of claim 1.

15. A method of performing a droplet operation, the method comprising manipulating magnetic beads in the digital microfluidic device of claim 1.

16. A method of manufacturing a composite substrate, the method comprising: forming a plurality of penetrations in a substrate of a first material, and
inserting in the penetrations a second material having a higher magnetic permeability than the first material, wherein at least a portion of the substrate comprises 5 to 50 penetrations per square centimeter.

17. The method of claim 16, wherein the first material wherein the first material is selected from the group consisting of glass, polymethylmethacrylate, polycarbonate, polyethylene terephthalate (PET), polyimide, and combinations thereof.

18. The method of claim 16 or claim 17, wherein the second material is a metal or metal alloy.

19. A digital microfluidic device, comprising:
(a) a bottom plate comprising a plurality of pixel electrodes;
(b) a composite top plate comprising:
a top plate substrate of a first material;
a top plate common electrode, and
a plurality of penetrations through the top plate substrate, wherein at least one of the penetrations contains a second material having at least one of: a higher thermal conductivity than the first material, and a higher magnetic permeability than the first material;
wherein:
(i) the top plate and the bottom plate are provided in a spaced relationship defining a microfluidic space therebetween; and
(ii) the penetrations create at least one high-resolution zone in the microfluidic space, wherein the high-resolution zone has at least one of: a higher thermal resolution than in the digital microfluidic device without the penetrations, and a higher magnetic resolution than in the digital microfluidic device without the penetrations.

20. The digital microfluidic device of claim 19, wherein a ratio k₂:k₁ is at least 10:1, wherein k₁ is the thermal conductivity of the first material and k₂ is the thermal conductivity of the second material.

21. The digital microfluidic device of claim 19, wherein a ratio μ₂: μ₁ is at least 10:1, wherein μ₁ is the magnetic relative permeability of the first material and μ₂ is the magnetic relative permeability of the second material.

22. The digital microfluidic device of claim 19, wherein at least a portion of the top plate substrate comprises 5 to 50 penetrations per square centimeter.
